(19) United States
(12) Patent Application Publication
(10) Pub. No.: US 2019/0364030 A1
(43) Pub. Date: Nov. 28, 2019

(54) TWO-STEP AUTHENTICATION METHOD, DEVICE AND CORRESPONDING COMPUTER PROGRAM

(71) Applicant: CMX SECURITY, Les Moulieres (FR)

(72) Inventor: Cedric Bornecque, Les Molieres (FR)

(21) Appl. No.: 16/477,731

(22) PCT Filed: Jan. 8, 2018
(86) PCT No.: PCT/EP2018/050332

§ 371 Date: Jul. 12, 2019

(30) Foreign Application Priority Data
Jan. 13, 2017 (FR) 1750295

(51) Int. Cl. H04L 29/06

(52) U.S. Cl. CPC H04L 63/083; H04L 63/0853; H04L 63/107

(57) ABSTRACT

A method of authenticating a user, implemented when the user accesses an online service, which is accessible in a server through an access terminal. The method includes: dissemination, by the access terminal, of a first piece of authentication data; obtaining by an authentication terminal, the first piece of authentication data; connection, by the authentication terminal, to the server at a resource-location address derived from the first piece of authentication data; obtaining, by the server, of at least one piece of identification data for identifying the authentication terminal; and when the at least one piece of identification data for identifying the authentication terminal corresponds to piece of data pre-recorded in the server: transmission, to the access terminal, of a piece of data representing a page for entering a personal identification code of the user; and displaying, by the access terminal, the page for entering a personal identification code.

### 1. FIELD OF THE INVENTION

The present technique relates to the authentication of users with online service provider devices. The present technique relates more particularly to the authentication of users who wish to access an online user space by means of a server. More specifically again, a technique is presented for accessing an online service comprising dual authentication.

### 2. PRIOR ART

When a user of an online service wishes to access a personal space or an account that belongs to him, it is very frequent for an identifier (or ID) and a password to be requested. The user must then enter the ID and the password that he has generally chosen in order to access this account or personal space. Access to the online service, just like the entry of the ID/password pair, is generally done through a communications terminal (such as a computer, tablet or telephone) that is generally connected to a communications network. The communications terminal generally executes an application that sets up one or more connections, through the communications network, to a server (an electronic device) that takes responsibility for verifying the authenticity of the data entered by the user and of allowing (or not allowing) access to the online service, the account or the personal space. The ID/password pair is used by the server to determine who is the user (ID) and verify that he has the required data (password). It is known that this method is ultimately not very secure. This relative weakness of this type of system relates to several factors. Among them we can cite especially the fact that the passwords used by users are often low-resistance passwords. There is also the fact that the systems to which it is necessary to get connected comprise security flaws of varying degrees (lack of resistance to SQL injection for example or low resistance to re-routing, absence of encryption etc.). Major efforts have been made to make systems more resistant, especially for example by the widespread use of tracking mechanisms aimed at having additional information on the person trying to get connected to an online service (for example recovering the IP address of the communications terminal through which the user gets connected). A useful system, although not widely used, consists in making the user enter one-time use data.

The principle is as follows:
Through a first terminal, the user enters his identifier or ID, and confirms it;
upon reception of the entry of this ID, the server generates a one-time use piece of data which it transmits to the user on a second terminal (different from the first terminal through which the user is trying to get connected);
the user consults this second terminal and enters the piece of one-time use data (jointly or not jointly with his password) on the first terminal and confirms this entry;
the server receives the data coming from the first terminal and verifies firstly that the password coincides with the password recorded in the base and secondly that the one-time use data correspond to pieces of data previously transmitted.

The level of security offered by this type of system is effectively far higher than that of the simple ID/password pair. However, this type of system also has problems. The first problem lies in the duration of validity of the piece of one-time use data. Indeed, to make the use of this system as comfortable as possible, the pieces of one-time use data generally have a life of about one minute. This must effectively enable the user to take possession of the second communications terminal, unlock it and obtain knowledge of the one-time use data. Now this period of time can be profitably used, for example by a hacker who has installed a spyware on the first communications terminal, to intercept the password and the one-time use data and get connected to the system in place of the legitimate user. This type of attack, which is well known, can be implemented by means of dynamic re-routing (after the entry of the ID and before the entry of the password/one-time use data) to a site that perfectly imitates the site of the service to which the user is trying to get connected. This raises problems for example when the site in question is a bank site or a site containing sensitive data.

An incident problem is related to the fact that the user is obliged to enter additional data. Now it is known that errors resulting from entry are frequent. Hence, with this type of system, if the user commits an error of entry (for example entry of one-time use data) he is obliged to recommence the entire connection procedure. What is more, the one-time use data can generally be transmitted to the user by means of an SMS type message requiring the user to provide his telephone number to the online services, something that he is not necessarily willing to do.

There is therefore a need to provide a solution of connection to online services that is simpler and more efficient than the services presented here above.

### 3. SUMMARY OF THE INVENTION

The proposed technique does not have these drawbacks of the prior art. More particularly, the proposed technique implements a principle of dual authentication, using two different communications terminals. More particularly, the invention relates to a method of authentication of a user, a method implemented when said user accesses an online service, said online service being accessible in a server through an access terminal.

Such a method comprises:
a step of dissemination, by the access terminal, of a first piece of authentication data;
a step of obtaining, by an authentication terminal, of said first piece of authentication data;
a step of connection, by said authentication terminal, to the server at a resource-location address derived from the first piece of authentication data;
a step of obtaining, by the server, of at least one piece of identification data for identifying said authentication terminal; and
when said at least one piece of identification data for identifying said authentication terminal corresponds to piece of data pre-recorded in said server:
   a step of transmission, to said access terminal, of a piece of data representing a page for entering a personal identification code of said user;
   a step of display, by said access terminal, of said page for entering a personal identification code.

Thus, unlike in the prior art method, the user does not need to enter one-time use data. Besides, the proposed method is not vulnerable to attempts at dynamic re-routing nor is it vulnerable to attempts at identity theft. Finally, the proposed method does not require the user to provide the services with additional personal data.

According to one particular characteristic, the method furthermore comprises, subsequently to said display step, a step for issuing, to said access terminal, a first assertion of authentication as a function of a personal authentication code entered by said user.

Thus a complete authentication is carried out, both of the user and of his authentication terminal.

According to one particular characteristic, prior to the dissemination step, the method comprises:
a step of connection of said access terminal to a resource-location address for access to said service with said server;
a step of detection, by said server, of a need for authentication; and
when the need for authentication is detected, a step of transmission to said access terminal of said first piece of identification data.

Thus, the server uses the access terminal as a vector of dissemination of a piece of information intended for the authentication terminal which, by the nature of the dissemination, is close at hand to the access terminal.

According to one particular characteristic, prior to said step of transmission of said first piece of identification data, the method comprises a step for generating said first piece of identification data that comprises:
a step for generating a resource-location address;
a step for encoding the resource-location address as a function of at least one pre-determined encoding parameter issuing said first piece of identification data.

Thus, the location address is not accessible to one and all. It is especially inaccessible to fraudulent information-capturing devices if any.

According to one particular characteristic, the resource-location address is temporary.

Thus, even in the case of fraudulent capturing, the location address cannot be used several times.

According to one particular characteristic, the duration of validity of said resource-location address is from 10 to 20 seconds.

According to one particular characteristic, the method furthermore comprises the following steps, subsequently to said step of display of said page for entering a personal identification code:
a step for comparing an authentication code entered by said user with an authentication code pre-recorded within said server; and
when said authentication code entered by the user corresponds to said authentication code pre-recorded in said server;
   a step of comparison of a current location of said authentication terminal with at least one pre-authorized location of said authentication terminal; and
   when the current location of said authentication terminal corresponds to a pre-authorized location, a step for issuing said first assertion of authentication to said access terminal.

Thus, it is impossible for the authentication terminal and the access terminal not to be situated at locations that are pre-defined and relatively near to each other.

According to one particular characteristic, the first piece of authentication data takes the form of a 2D bar code.

According to one particular characteristic, the step for issuing said first assertion of authentication to said access terminal comprises:
a step of transmission, to said access terminal, of a data structure for the entry of connection data;
   and in that said method further comprises:
at least one step of verification, by said server, that a piece of connection data entered by said user on said access terminal corresponds to a piece of pre-recorded connection data; and
when said piece of connection data entered by said user on said access terminal corresponds to a pre-recorded piece of connection data:
a step for issuing a second assertion of authentication to said access terminal.

According to another aspect, the present technique also relates to a system configured to enable an authentication of a user, a system enabling an implementation during an access of said user to an online service, said online service being accessible through a server, by means of an access terminal. Such a system comprises:
means of dissemination, by the access terminal, of a first piece of authentication data;
means for the obtaining, by an authentication terminal, of said first piece of authentication data;
means for the connection by said authentication terminal, to the server at a resource-location address derived from said first piece of authentication data;
means for the obtaining, by the server, of at least one piece of identification data for identifying said authentication terminal; and
means implemented when said at least one piece of identification data for identifying said authentication terminal corresponds to a piece of data pre-recorded in said server, comprising:
   means of transmission, to said access terminal, of a piece of data representing a page for entry of a personal identification code of said user;
   means of display, by said access terminal, of said page for entry of a personal identification code.

According to another aspect, the present technique also relates to a server for the two-step authentication of a user.

According to another aspect, the present invention also relates to an authentication terminal comprising means for implementing the present technique.

According to a preferred implementation, the different steps of the methods according to the invention are performed by one or more software programs or computer programs comprising software instructions that are to be executed by a data processor according to the invention and are designed to control the execution of the different steps of the methods.

The invention is therefore aimed at providing a program capable of being executed by a computer or by a data processor, this program comprising instructions to command the execution of the steps of a method as mentioned here above.

This program can use any programming language whatsoever and can be in the form of source code, object code or intermediate code between source code and object code such as in a partially compiled form or in any other desirable form whatsoever.

The invention is also aimed at providing an information carrier or medium readable by a data processor, and comprising instructions of a program as mentioned here above.

The information medium can be any entity or device whatsoever capable of storing the program. For example, the medium can comprise a storage means such as a ROM, for example, a CD ROM or microelectronic circuit ROM or again a magnetic recording means, for example a floppy disk or a hard disk drive.

Besides, the information support can be a transmissible support such as an electrical or optical signal, that can be conveyed by an element or optical cable, by radio or by other means. The program according to the invention can be especially downloaded from an Internet type network.

As an alternative, the information carrier can be an integrated circuit into which the program is incorporated, the circuit being adapted to execute or to be used in the execution of the method in question.

According to one embodiment, the proposed technique is implemented by means of software and/or hardware components. In this respect, the term “module” can correspond in this document equally well to a software component and to a hardware component or to a set of hardware and software components.

A software component corresponds to one or more computer programs, one or more sub-programs of a program or more generally to any element of a program or a piece of software capable of implementing a function or a set of functions according to what is described here below for the module concerned. Such a software component is executed by a data processor of a physical entity (terminal, server, gateway, router etc) and is capable of accessing the hardware resources of this physical entity (memories, recording media, communications buses, input/output electronic boards, user interfaces etc).

In the same way, a hardware component corresponds to any element of a hardware assembly capable of implementing a function or a set of functions according to what is described here below for the module concerned. It can be a programmable hardware component or a component with an integrated processor for the execution of software, for example, an integrated circuit, smart card, a memory card, an electronic board for the execution of firmware etc.

Each component of the system described here above can of course implement its own software modules.

The different embodiments mentioned here above as well as the different characteristics of the constituent elements can be combined with one another to implement the proposed technique.

### 4. DRAWINGS

Other features and advantages of the invention shall appear more clearly from the following description of a preferred embodiment, given by way of a simple illustratory and non-exhaustive example and from the appended drawings, of which:

FIG. 1 presents the different steps of authentication of the technique;

FIG. 2 presents the steps prior to the authentication according to one embodiment;

FIG. 3 discloses a server seen in a synthesized view;

FIG. 4 discloses an authentication terminal seen in a synthesized view.

### 5. DETAILED DESCRIPTION

### 5.1. Reminder of the Principle of the Invention

As explained here above, the general principle of the invention consists in performing a dual authentication: an authentication of a terminal (which is a communications terminal of the user) followed by an identification of the user himself. More particularly, unlike the existing methods of authentication, the method authenticates a terminal of the user. It is not the terminal with which the user tries to get connected to the service that is authenticated (this terminal is called the access terminal) but actually a second terminal, called an authentication terminal, one of the roles of which is to prove that the user possesses this terminal and that it is truly the terminal needed to authorize access to the online service.

As described in detail here below, the authentication terminal can be authenticated only after a registration phase. The registration of the authentication terminal is carried out by a method of registration implemented by the user during his own registration (or during his own registration with the online service).

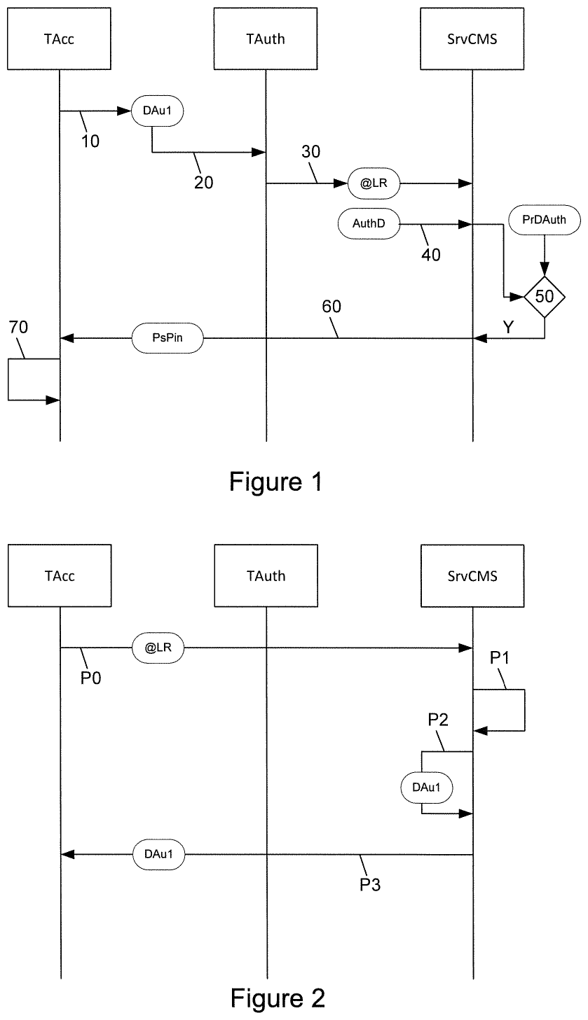

FIG. 1 gives a general view of the dual authentication according to the present technique. The method comprises:
a step of dissemination (10), by the access terminal (TAcc), of a first piece of authentication data (DAu1);
a step for the obtaining (20), by an authentication terminal (TAuth), of said first authentication data (DAu1);
a step for the connection (30), by said authentication terminal (TAuth), to the server (SrvCMS) at a resource-location address (@LR) derived from said first authentication data (DAu1);
a step for the obtaining (40), by the server (SrvCMS), of at least one piece of identification data (AuthD) of said authentication terminal (TAuth); and
when (50) said at least one piece of authentication data (AuthD) of said authentication terminal (TAuth) corresponds to a piece of data pre-recorded (PrDAuth) within said server (SrvCMS):
a step of transmission (60), to said access terminal, of a piece of data representing a page for entering a personal identification code (PsPin) of said user;
a step of display (70), by said access terminal, of said page for entering a personal identification code.

It is worth noting that, according to the invention, it is the access terminal (which potentially can be any terminal whatsoever) that is used to start the authentication of the authentication terminal. Unlike prior art techniques, for example the technique for the transmission of an SMS to a second terminal, the online service (and therefore the server SrvCMS) controls, through the access terminal, the location of the authentication terminal. Indeed, the fact that the authentication terminal must obtain a piece of data from the access terminal necessarily implies the (physical) presence of the authentication terminal with the user. It is therefore not possible to carry out a remote “hacking” of the authentication terminal because this terminal is necessarily in the presence of the access terminal. Besides, in one variant, it is a compulsorily required that the user of the authentication terminal should share his location data: this enables verification that the location data of the authentication terminal tallies with the location data of the access terminal.

The dissemination, by the access terminal, of the piece of authentication data can be carried out in different ways, each of which has advantages in view of the present technique. In one first embodiment, the dissemination can be implemented by carrying out a display, on the screen, of the piece of authentication data, for example in encoded form, that only the authentication terminal can read (for example a piece of data displayed on the screen and captured by a movie or photo camera of the authentication terminal). In a second embodiment, the dissemination can be implemented in the form of a sound comprising the authentication data. In a third embodiment, the authentication data be disseminated in the form of wireless data, of the Wi-Fi or Bluetooth or NFC type.

The authentication terminal uses appropriate means (a movie camera, a photo camera, a microphone, a wireless resource) to obtain the authentication data intended for it. Using an appropriate application, it decodes this authentication data and logs into a resource-location address (for example a URL) provided by the server: the connection to this resource-location address enables the server to obtain authentication data for authenticating the authentication terminal. There are several types of identification data: data proper to the terminal itself and complementary data. The data proper to the terminal are obtained directly at connection by means of the application which gets connected to the server. The invention, to this end, for example, advantageously makes use of an imprint of the authentication terminal (for example the imprint of a browser) and/or a “bearer” accompanying the request for connection to the server and/or an HTTP header and/or one or more cookies (comprising a unique identification of the authentication terminal), present on the authentication terminal and accompanying the request for connection to the server. The server compares the data that it obtains with pre-recorded data (for example pre-recorded at the time of registration of the authentication terminal) and, when this data corresponds to the expected data, it activates the display of a connection page intended for the user on the access terminal. The complementary data are data that come from a dialog between the authentication terminal and the server.

Referring to FIG. 2, we describe the steps prior to the dissemination according to one particular embodiment. The method comprises:
a step of connection (P0) of said access terminal (TAcc) to a resource-location address (@LRO) for access to said service with said server (SrvCMS);
a step of detection (P1), by said server (SrvCMS), of a need for authentication; and
a step of generation (P2) of said first piece of authentication data (DAu1) which comprises:
   a step for generating a resource-location address (@LR);
   a step for encoding the resource-location address (@LR) as a function of at least one pre-determined encoding parameter, delivering said first piece of identification data (DAu1).
when a need for connection is detected, a step of transmission (P3) to said access terminal (TAcc), of said first identification data (DAu1).

Naturally, this constitutes the basic exchanges enabling a dual authentication. A more complex mode is especially provided in which the exchanges between the authentication terminal and the server enable a more complete authentication of the authentication terminal. This mode is described in detail here below.

### 5.2. Description of One Embodiment

In this embodiment, the piece of authentication data is displayed on the screen by the access terminal. It is displayed for example in the form of a QR Code or again a watermarked image. The authentication data has a limited lifetime. This lifetime is however smaller than in the prior art and this is the case for the following reason: the piece of authentication data is not entered or used by a human being. Its processing is carried out by the authentication terminal. This processing is appreciably faster than is the case with a human being. It is therefore not necessary for the lifetime of this piece of authentication data to be long. This also limits the risk that this piece of authentication data will be fraudulently obtained and used. Thus, the step of dissemination is a step of display of a QR Code defined by the server. The authentication terminal, for example the user's smartphone, is used to capture this QR Code.

In this embodiment, two variants are implemented:
the first, non-restrictive variant consist in not encrypting the data present in the QR Code and enabling anybody whatsoever to access the resource-location address contained in the QR Code;
the second variant, on the contrary, is based on knowledge, on the part of the authentication terminal (the user's smartphone) and the server, of one or more encryption keys and is based on the encryption of this piece of data in the QR Code.

The first variant has the advantage of not requiring prior knowledge on the part of the smartphone. At the same time, it offers the hacker the possibility of having available a piece of authentication data (the URL) so as to access the data himself. This disadvantage is counterbalanced by the relatively short lifetime of the authentication data, making its use by another device (the attacker's device) difficult or even impossible. The second variant has the advantage of being more secure but requires that the authentication terminal and the server should preliminarily exchange one or more encryption keys to carry out the operation of encryption/decryption of the piece of authentication data present in the QR Code.

Once the authentication data have been decoded (whether directly or through the QR Code or by means of an encryption operation), the authentication terminal gets connected to the URL (of the https://auth.myserver.com type) contained in the piece of authentication data. This URL comprises an ID and (optional) complementary data, as a function of the embodiments. It thus takes the form:
https://auth.myserver.com/?id=XXXXXXXX&comp=YYYYYYYY.

The authentication terminal gets connected to this URL by transmitting an http(s) request to the server, a request that also comprises (especially) the imprint of the browser (it can be noted that this imprint can either be directly deduced from the first request transmitted by the browser to the server or comes from a dialog between the browser and the server).

Upon reception of this request (and/or of the imprint when it requires several browser/server exchanges) the server (optionally) implements the following two steps:
display, on the authentication terminal, of an authentication page;
display, on the access terminal, of a message indicating that an authorization of an authentication terminal is in progress in order to enable the user to note that the process is in progress.

On the authentication terminal, the display of an authentication page is possible only if the authentication terminal has been recognized (by the server) especially by means of its imprint and/or cookies that it contains. When the authentication terminal is not recognized, the authentication page is replaced by a page denoting impossibility of access to the service.

The authentication page, when displayed, comprises a zone of entry of a piece of personal identification data (to the user). This can be a PIN code or a password. The user is then requested to enter this piece of personal identification data on the authentication terminal. To this end, he can have a pre-defined number of attempts (for example three attempts) at his disposal. He also has an pre-defined, allotted time available (for example 30 seconds) to make this entry.

When the entry is correct (i.e. when the result of this entry is the result expected by the server in a response (of the POST type) made by the authentication terminal, a page denoting success is transmitted by the server to the authentication terminal and the server displays (on the access terminal), a (classic) user connection page. The user then enters his log-in/password to access the service. The second classic authentication by log-in/password is thus made possible only through success with the first authentication (the authentication of the authentication terminal). As explained here above, the display of a page for entry of a personal identification code of the user is optional. The entry of such a code increase security.

To implement the methods described, the server comprises a data base that comprises a table of users listing the users (ID, password, electronic mail addresses). This data base also comprises a table of authentication terminals listing the authentication terminals. The attributes of these tables comprise especially the imprint of the terminal, computed during the registration of the terminal in the system. This imprint is unique and is used as an identifier of the authentication terminal. When the imprint changes, the authentication terminal is no longer recognized and therefore tacitly revoked. In order that the terminal might be again recognized, a registration of it has to be made. The table of authentication terminals includes other fields that are described in detail here below with reference to the description of the processes of registration, revocation, creation of cookies. The base also comprises a table enabling the tracing of the associations between the users and the authentication terminals.

The location data for their part comprise data obtained through the IP address of the different devices (access terminal, authentication terminal): depending on the embodiments, these pieces of data can be obtained by the server subsequently to the obtaining of the IP addresses, by means of a request of interrogation to an IP address location service. The server (or user) can define an authorized (reference) location of greater or lesser extent and this location can be used to accept (or not accept) an authentication from the authentication terminal. In addition, when the authentication terminal has a processor for obtaining location data (GPS, Glonass, etc.), this data is provided by the authentication terminal to the server which uses it to authorize or not authorize a connection. This data takes the form of longitude/latitude type coordinates.

The advantages provided by this system are many. The system especially makes it possible to do without complex securing architectures while providing a high level of security. It is simple to implement and does not require any specific application to be installed on the authentication terminal. A specific application however can be installed for the requirements of data persistence, for example, but even this type of application is simple to build and maintain.

### 5.3. Other Characteristics and Advantages

The method of dual authentication presented here above can advantageously be coupled with a set of optional methods of registration (of an authentication terminal, user), revocation (of an authentication terminal, user, access terminal) and generation of authentication data. These different methods are presented here below.

### 5.3.1. Process of Registration of the First User

The process of registration is activated automatically for a terminal not recognized by the system (no cookie, no known authentication imprint), as follows:
[1] accessing the connection page which presents the QR Code with one-time use and limited lifetime; p0 [2] scan by a mobile terminal that has not yet been registered. The scan of the QR Code activates the URL call which has the following consequences:
   a. informing the user that his terminal is not yet known;
   b. requesting his agreement to the steps c and d (if not the registration fails);
   c. depositing a cookie (on the authentication terminal) which will be preserved;
   d. geolocating the terminal and preserving a trace of this position;
   e. generating a javascript authentication signature that is preserved to authenticate the terminal.
[3] displaying a table asking the user to enter his user electronic mail address, which results in:
   a. transmitting an electronic email to this address with an activation link that must compulsorily be open from the same terminal (same cookie, same location, same signature);
   b. if necessary, a second electronic mail is sent to a second electronic mail address or an SMS is sent for cases where the security is more sensitive;
   c. building, within the server, an association between the authentication terminal and the user; this terminal therefore cannot be used for a second user unless the registration process is repeated for a new additional user.
[4] at the end of the step [3], a personal identification code can optionally be configured by the user. This personal identification code is proper to the terminal and will be thereafter requested at each authentication.

### 5.3.2. Process of Registration for an Additional User

If the terminal has already been registered for a first user, the QR Code enables access to the connection page and the entry of another log-in/password combination: this is not accepted by the system.

When this unusual case occurs and only if the log-in/password combination is accurately entered for the new user, the registration page is proposed in order to carry out a new association of a user with the authentication terminal (i.e. for the transmission of an electronic mail to the address of the new user with a registration link).

### 5.3.3. Failure of Registration

The registration can fail in the following cases, which represent measures of security provided by the system:
the confirmation link transmitted by the electronic mail has not been called within the allotted time limit from the authentication terminal;
the SMS has not been confirmed within the allotted time limit;
the user refuses to share his position;
the previous registration has failed (except in the above three cases);
the terminal has already been registered and then revoked for security reasons (same cookie/imprint/IP address);
the geographical location is inconsistent with the authorizations of the system;
the terminal is rooted whereas this is not authorized by the system;
the GPS position is inconsistent with the IP address of the terminal;
the IP address authorized for the terminal is not private whereas it is imposed;
the IP address is blacklisted following a previous revocation from this address; if necessary, the IP address can be combined with the signature and the value of the cookie, for greater precision and security.

A registration failure can be the object of an entry in the log and possibly the object of an electronic mail.

### 5.3.4. Revocation of an Authentication Terminal

A terminal already registered can be automatically revoked when a behavior assumed to be fraudulent is detected:
wrong personal identification code typed in several times (for example three times) after the scanning of the QR Code;
geographical inconsistency of the authentication terminal with the position of the access terminal;
geographical inconsistency of the authentication terminal with zones authorized for consultation (geographical zones obtained by means of a location of the IP address);
the terminal is suddenly “rooted” whereas it was not rooted earlier;
number of readings of the QR Code is greater (for example three times greater) than a defined threshold;
variable part incorrect in the cookie;
several attempts ((for example three attempts) to register the terminal for a new user without knowing the log-in/password pair.

A terminal can also be revoked manually by an authorized administrator. The revocation of a terminal is the subject of an alert by electronic mail and the addition of an entry in the log. The user of the terminal is informed that his terminal has been revoked and that he cannot register a new terminal during the next QR Code scan.

### 5.3.5. Registering an Access Terminal

The registration of an access terminal is transparent for the user and simply implies that a cookie is deposited for subsequent recognition (if necessary) and that the user agrees to share his position.

An imprint is generated and preserved but, in principle, it cannot be used to identify a terminal with certainty. This is logical since the access terminal can be a terminal situated in a public place (library, cybercafé, etc.).

There is no case of failure in the registration of an access terminal. This is unnecessary because only the authentication terminal enables access to the connection page from an access terminal (even an unknown one).

### 5.3.6. Revocation of an Access Terminal

An already registered access terminal can be revoked automatically following supposedly fraudulent actions from the authentication terminal when a supposedly fraudulent behavior is detected from this terminal. The actions are the same as those that lead to the revocation of the authentication terminal.

### 5.3.7. Association Between User and Authentication Terminal

The system makes it possible to preserve an n-n type association between the users and one or more authentication and consultation terminals. Hence:
a user can have several authentication and consultation terminals;
several users can get connected by means of the same authentication and consultation terminals.

The purpose of this association is not to enable a connection of the user but to ascertain that the terminal is truly authorized to provide access to the user's connection page. Another user cannot get connected from this terminal unless he has carried out a new step for registering this terminal.

The association is also implemented to make the traceability of the terminals and of their users during the connection request effectives. It then makes it possible to manage alerts and possibly revoke other terminals and deactivate users' accounts.

### 5.3.8. Securing a User Account

As a security measure, the system can if necessary, deactivate a user account that has been associated with a terminal that has just been revoked. The reactivation can then be done by an administrator.

### 5.3.9. Generation of the Cookie

Each authentication and consultation terminal receive a cookie, the value of which is renewed at each visit. The content of the cookie can be sub-divided into:
One fixed and unique part per terminal (hash of the imprint combined with a timestamp);
a variable part recomputed at each visit (a timestamp hash).

At each visit, the variable part is recomputed and preserved in the base of the server for subsequent comparison.

In the case of theft of a cookie, the variable part enables the identification of a sequence error and the fixed part makes it possible to retrieve the terminal and carry out revocations.

### 5.4. Implementing Devices

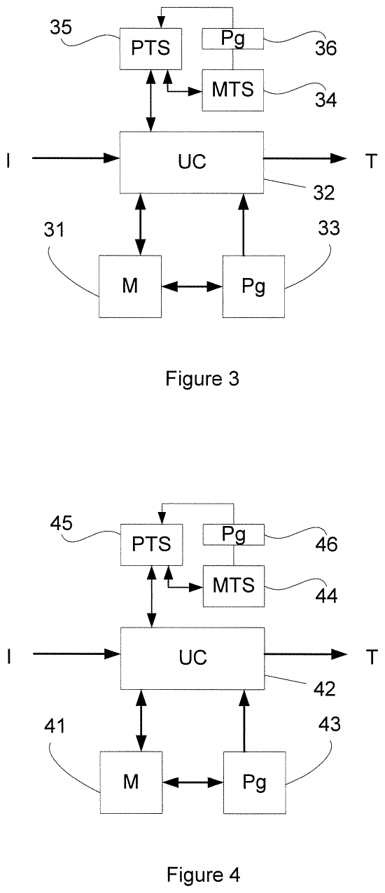

Referring to FIG. 3, we describe a server (SrvCMS) implemented for the two-step management of the authentication of a user with a service by using an access terminal and an authentication terminal according to the method described here above.

For example, the server (SrvCMS) comprises a memory 31 comprising for example a buffer memory, a general processor 32, equipped for example with a microprocessor and driven by a computer program 33, and/or a secure memory 34, a secure processor 35, controlled by a computer program 36, these processing units implementing data-processing methods as described here above to carry out authentication processing operations, namely authentication processing operations parametrized as a function of the presence (or non-presence) of a piece of reference authentication data within the server, a piece of data serving for comparison with a piece of current authentication data coming from the authentication terminal.

At initialization, the code instructions of the computer program 36 are for example loaded into a memory and then executed by the secure processor 35. The secure processor 35 inputs at least one piece of data representing a request for connection to the service. The secure processor 35 implements the steps of the method of authentication according to the instructions of the computer program 36 to obtain a piece of authentication data for authenticating the terminal and a piece of reference authentication data to be compared.

To this end, the server (SrvCMS) furthermore comprises a memory 34, communications means such as network communications modules, data transmission means and data transmission circuits for transmission of data between the various components of the server.

The means described here above can take the form of a particular processor implemented within a specific device implanted within the server. According to one particular embodiment, the server ((SrvCMS) implements a particular application which is in charge of carrying out the operations described here above, this application being for example provided by the manufacturer of the processor in question in order to enable the use of said processor. To this end, the processor comprises unique identification means. These unique identification means ensure the authenticity of the processor.

Referring to FIG. 4, we describe an authentication terminal (TAuth) implemented for the two-step management of the authentication of a user with a service in using an access terminal and a server (SrvCMS) according to the method described here above.

For example, the authentication terminal (TAuth) comprises a memory 41 comprising for example a buffer memory, a general processor 42, equipped for example with a microprocessor and controlled by a computer program 43, and/or a secure memory 44, a secure processor 45 controlled by a computer program 46, these processing units implementing methods of data processing as described here above to carry out authentication processing operations, namely authentication processing operations that are parametrized as a function of the presence (or absence) of a piece of reference authentication data, within the authentication terminal, a piece of data that serves for comparison with a piece of reference authentication data preliminarily obtained and accessible from the server.

At initialization, the code instructions of the computer program 46 are for example loaded into a memory and then executed by the secure processor 45, the processor 45 inputs at least one piece of data representing a request for connection to the service. The secure processor 45 implements the steps of the authentication method according to the instructions of the computer program 46 to obtain a piece of authentication data for authenticating the terminal and a piece of reference authentication data to be compared.

To this end, the authentication terminal (TAuth) comprises, in addition to the memory 44, communications means such as network communications modules, data transmission means and transmission circuits for the transmission of data between the various components of the server.

The means described here above can take the form of a particular processor implemented within a specific device implanted within the authentication terminal. According to one particular embodiment, the authentication terminal (TAuth) implements a particular application that is in charge of carrying out the operations described here above, this application being for example provided by the manufacturer of the processor in question in order to enable the use of said processor. To this end, the processor comprises unique identification means. These unique identification means ensure the authenticity of the processor.

1. A method of authentication of a user, a method being implemented when said user accesses an online service, said online service being accessible in a server through an access terminal, wherein the method comprises:
dissemination, by the access terminal, of a first piece of authentication data;
obtaining by an authentication terminal, of said first piece of authentication data;
connection, by said authentication terminal, to the server at a resource-location address derived from said first piece of authentication data;
obtaining, by the server, of at least one piece of identification data for identifying said authentication terminal; and
when said at least one piece of identification data for identifying said authentication terminal corresponds to piece of data pre-recorded in said server:
transmission, to said access terminal, of a piece of data representing a page for entering a personal identification code of said user;
displaying, by said access terminal, of said page for entering a personal identification code.

2. The method of authentication according to claim 1, wherein the method further comprises, subsequently to said displaying issuing, to said access terminal, a first assertion of authentication as a function of a personal authentication code entered by said user.

3. The method of authentication according to claim 1 wherein the method further comprises, prior to the dissemination:
connection of said access terminal to a resource-location address for access to said service with said server;
detection, by said server, of a need for authentication; and
when the need for connection is detected, transmission, to said access terminal, of said first piece of identification data;

4. The method of authentication according to claim 3 that the method comprises, prior to said transmission of said first piece of identification data, generating said first piece of identification data, which comprises:
generating a resource-location address;
encoding the resource-location address as a function of at least one pre-determined encoding parameter issuing said first piece of identification data.

5. The method of authentication according to claim 1, wherein the resource-location address is temporary.

6. The method of authentication according to claim 5, wherein a duration of validity of said resource-location address is from 10 to 20 seconds.

7. The method of authentication according to claim 1, wherein the method furthermore comprises the following acts, subsequently to said display of said page for entering a personal identification code:
comparing an authentication code entered by said user with an authentication code pre-recorded within said server; and
when said authentication code entered by the user corresponds to said authentication code pre-recorded in said server:
comparison of a current location of said authentication terminal with at least one pre-authorized location of said authentication terminal; and
when the current location of said authentication terminal corresponds to a pre-authorized location, issuing said first assertion of authentication to said access terminal.

8. The method of authentication according to claim 1, wherein said first piece of authentication data takes the form of a two-dimensional (2D) bar code.

9. The method of authentication according to claim 2, wherein said issuing said first assertion of authentication to said access terminal comprises:
transmission, to said access terminal, of a data structure for the entry of connection data;
and said method further comprises:
at least one act of verification, by said server, that a piece of connection data entered by said user on said access terminal corresponds to a piece of pre-recorded connection data; and
when said piece of connection data entered by said user on said access terminal corresponds to a pre-recorded piece of connection data:
issuing a second assertion of authentication to said access terminal.

10. A system configured to enable an authentication of a user, a system enabling an implementation during an access of said user to an online service, said online service being accessible through a server, by means of an access terminal, wherein the system comprises:
means for dissemination, by the access terminal, of a first piece of authentication data;
means for obtaining, by an authentication terminal, said first piece of authentication data;
means for connection, by said authentication terminal, to the server at a resource-location address derived from said first piece of authentication data;
means for obtaining, by the server, of at least one piece of identification data for identifying said authentication terminal; and
means implemented when said at least one piece of identification data for identifying said authentication terminal corresponds to a piece of data pre-recorded in said server, comprising:
means of transmission, to said access terminal, of a piece of data representing a page for entry of a personal identification code of said user;
means of display, by said access terminal, of said page for entry of a personal identification code.
